(19) United States
(12) Patent Application Publication
(10) Pub. No.: US 2025/0355676 A1
(43) Pub. Date: Nov. 20, 2025

(54) IN-VEHICLE INFOTAINMENT SYSTEM AND OPERATION CONTROL METHOD THEREOF

(71) Applicants: Hyundai Motor Company, Seoul (KR); Kia Corporation, Seoul (KR)

(72) Inventors: Yunjoong Park, Hwaseong-si (KR); Jeongtaek Oh, Hwaseong-si (KR)

(21) Appl. No.: 18/945,706

(22) Filed: Nov. 13, 2024

(30) Foreign Application Priority Data
May 17, 2024 (KR) 10-2024-0064777

(51) Int. Cl. G06F 9/4401; G06F 1/3212; G06F 1/3225; G06F 1/3234

(52) U.S. Cl. CPC G06F 9/4418; G06F 1/3212; G06F 1/3225; G06F 1/3275

(57) ABSTRACT

An in-vehicle infotainment (IVI) system of a vehicle can include a computing device for controlling an operation of the IVI system. The computing device may include a random access memory (RAM) for storing information necessary for an operation of the computing device, and suspended to RAM (STR) logic for controlling the IVI system in an STR mode when ignition or an accessory (ACC) of the vehicle is off. The computing device may provide an operating voltage to each of the RAM and the STR logic in the STR mode in accordance with the STR logic.

### CROSS-REFERENCE TO RELATED APPLICATIONS

This application claims priority to and the benefit of Korean Patent Application No. 10-2024-0064777 filed in the Korean Intellectual Property Office on May 17, 2024, the entire contents of which are incorporated herein by reference.

### TECHNICAL FIELD

The present disclosure relates to an in-vehicle infotainment (IVI) system and an operation control method of the IVI system.

### BACKGROUND

In-vehicle infotainment (IVI) systems boot up more frequently when users get in and out of a vehicle car frequently. The time taken for the IVI system to boot up may be a source of inconvenience to the user's experience in the vehicle. For example, a user may want to set a destination on a navigation system and leave immediately after getting in a vehicle, but the IVI system may not boot up, causing the user to inconveniently wait for the IVI system to boot up.

### SUMMARY

An embodiment of the present disclosure can provide an in-vehicle infotainment (IVI) system and an operation control method of the IVI system that may reduce the booting time of the IVI system.

An example embodiment of the present disclosure can provide an in-vehicle infotainment (IVI) system of a vehicle, the IVI system including a computing device for controlling an operation of the IVI system. The computing device may include a random access memory (RAM) for storing information necessary for an operation of the computing device, and suspended-to-random-access-memory (STR) logic for controlling the IVI system in an STR mode when ignition or an accessory (ACC) of the vehicle is off. The computing device may provide an operating voltage to each of the RAM and the STR logic in the STR mode in accordance with the STR logic.

When one of ignition on, ACC on, or CAN signal reception of the vehicle occurs in the STR mode, the IVI system may be switched to an active mode in which the IVI system operates according to a program executed by the computing device.

When the STR mode is switched to the active mode, quick booting of the IVI system may be performed, and in the quick booting, a booting operation of loading software to the RAM and an operation of initialization of the IVI system can be skipped.

The computing device may further include refresh logic for refresh-operating the RAM, and in the STR mode, according to the STR logic, the computing device provides an operating voltage to the refresh logic.

The IVI system may further include a battery and a power supply device for converting a voltage of the battery to supply the voltage to the IVI system. In the STR mode, the power supply device may generate the respective operating voltages of the STR logic and the RAM.

When the battery voltage of the battery becomes lower than a set, selected, or predetermined reference voltage, or an STR mode time in which the STR mode is maintained is longer than a set, selected, or predetermined reference time, the STR logic may switch the IVI system to a sleep mode.

The STR logic may count passage of time from time of start of control of the STR mode to generate an STR period of time, and, when the STR period of time is longer than a set, selected, or predetermined reference period of time, the STR logic may turn off the computing device to switch the IVI system to a sleep mode.

When any one of ignition on, ACC on, or CAN signal reception of the vehicle occurs, the IVI system may perform cold booting.

An example embodiment of the present disclosure can provide a method of controlling an operation of an in-vehicle infotainment (IVI) system of a vehicle, the method can include: controlling the IVI system in a suspended-to-random-access-memory (STR) mode when ignition or an accessory (ACC) of the vehicle is off; and supplying an operating voltage to each of a random access memory (RAM) and STR logic controlling the STR mode in the STR mode. The RAM may store information necessary for control of the IVI system.

The method may further include, when one of ignition on, ACC on, or CAN signal reception of the vehicle occurs in the STR mode, switching the IVI system to an active mode in which the IVI system operates according to an installed program.

The method may further include when the STR mode is switched to the active mode, performing quick booting of the IVI system. In the quick booting, a booting operation of loading software to the RAM and an operation of initialization of the IVI system can be skipped.

The method may further include refresh-operating the RAM by refresh logic, and in the STR mode, supplying an operating voltage to the refresh logic.

The method may further include when a battery voltage of a battery connected to a power supply device supplying voltage to the IVI system falls below a set, selected, or predetermined reference voltage, switching, by the STR logic, the IVI system to a sleep mode. The method may further include when an STR mode time in which the STR mode is maintained is longer than a set, selected, or predetermined reference time, switching, by the STR logic, the IVI system to a sleep mode.

The method may further include counting, by the STR logic, passage of time from time of start of control of the STR mode to generate an STR period of time, and when the STR period of time is longer than a set, selected, or predetermined reference period of time, switching, by the STR logic, the IVI system to a sleep mode.

The method may further include when any one of ignition on, ACC on, or CAN signal reception of the vehicle occurs, performing, by the IVI system, cold booting.

The example embodiments of the present disclosure provide the IVI system and the operation control method of the IVI system that may reduce the booting time of the IVI system.

### BRIEF DESCRIPTION OF THE DRAWINGS

FIG. 1 is a block diagram schematically illustrating a vehicle including an in-vehicle infotainment (IVI) system according to an example embodiment of the present disclosure.

FIGS. 2 to 5 are diagrams for illustrating an operation mode of an IVI system according to an example embodiment of the present disclosure.

FIG. 6 is a flowchart illustrating a method of booting the IVI system according to an example embodiment of the present disclosure.

### DETAILED DESCRIPTION OF ILLUSTRATIVE EMBODIMENTS

Hereinafter, example embodiments of the present specification will be described in detail with reference to the accompanying drawings, and same or similar constituent factors can be denoted by same reference numerals regardless of a reference numeral, and a repeated description thereof can be omitted. Further, the accompanying drawings are provided for helping to easily understand example embodiments disclosed in the present specification, and the technical spirit disclosed in the present specification is not necessarily limited by the accompanying drawings, and it can be appreciated that the present disclosure can include all of the modifications, equivalent matters, and substitutes included in the spirit and the technical scopes of the present disclosure.

Terms including an ordinary number, such as “first” and “second,” can be used for describing various components, but the components are not necessarily limited by such terms. Such terms can be used merely to discriminate one component from another component.

It can be understood that when one constituent element referred to as being “coupled to” or “connected to” another constituent element, one constituent element may be directly coupled to or connected to the other constituent element, but intervening elements may also be present. In contrast, when one constituent element is “directly coupled to” or “directly connected to” another constituent element, it can be understood that there are no intervening element present.

In the present disclosure, it can be appreciated that terms “including” and “having” are intended to designate the existence of characteristics, numbers, operations, operations, components, and components described in the specification or a combination thereof, and do not exclude a possibility of the existence or addition of one or more other characteristics, numbers, operations, operations, components, and components, or a combination thereof in advance.

Further, the configurations including the system described in the specification may be implemented in hardware or software, or a combination of hardware and software, to process at least one function or operation. In an embodiment of the present disclosure, a program may be implemented as a set of instructions embodying an algorithm for performing computations, control, and the like.

In the following, example embodiments will be described with reference to the accompanying drawings.

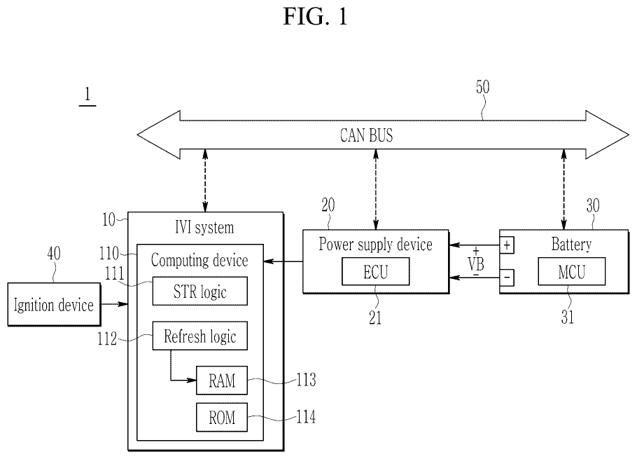

FIG. 1 is a block diagram schematically illustrating a vehicle including an in-vehicle infotainment (IVI) system according to an example embodiment of the present disclosure.

The vehicle 1 may include an IVI system 10, a power supply device 20, a battery 30, an ignition device 40, and a CAN bus 50, any combination of or all of which may be in plural or may include plural components thereof. In FIG. 1, CAN communication between the IVI system 10, the power supply device 20, and the battery 30 is shown to be performed via the CAN bus 50, but an embodiment of the present disclosure is not necessarily limited thereto. Via the CAN bus 50, CAN communication may be performed between various other devices, as well as the IVI system 10, the power supply device 20, and the battery 30, that configure the vehicle 1, even though not shown in FIG. 1.

The IVI system 10 may include a computing device 110. The computing device 110 can be configured to control the operation of the IVI system 10 and may have a plurality of programs installed that perform the services provided by the IVI system 10. The computing device 110 may perform a corresponding program of the plurality of programs in response to an instruction provided from the outside and/or an instruction generated by processing information provided from the outside. The instruction provided from the outside may be received via the CAN bus 50.

The computing device 110 may include suspend-to-ram (STR) logic 111, refresh logic 112, a random access memory (RAM) 113, a and read only memory (ROM) 114, any combination of or all of which may be in plural or may include plural components thereof.

The ROM 114 may store a plurality of programs executed by the computing device 110.

The RAM 113 may store information used for or necessary for the operation of the computing device 110. For example, the RAM 113 may store information used when or necessary when the computing device 110 boots up. The refresh logic 112 may perform a refresh operation of the RAM 113. A refresh operation can be an operation that replenishes the charge in the plurality of memory cells configuring the RAM 113 so that data stored in the plurality of memory cells is not lost due to charge leakage.

The computing device 110 may receive a termination instruction, such as an ignition off, and an accessory (ACC) off, of the vehicle 1. When the computing device 110 receives the termination instruction, the computing device 110 may operate under the control of the STR logic 111. An operation mode of the IVI system 10 when the computing device 110 operates under the control of the STR logic 111 can be referred to as an STR mode. An operation mode of the IVI system 10 when the computing device 110 executes a plurality of installed programs by ignition ON, ACC ON, CAN signal reception, and the like, and when the IVI system 10 operates, can be referred to as an active mode. An operation mode in which the computing device 110 is turned off and does not operate, and the IVI system 10 is in the off state in which the IVI system 10 also does not operate, can be referred to as a sleep mode. The CAN signal received by the IVI system 10 may be a signal that can command the IVI system 10 to boot up, received from other ECUs of the vehicle 1 other than the ignition device 40 of the vehicle 1.

In the STR mode, the computing device 110 may be operable by the STR logic 111 to supply respective operating voltages to the STR logic 111, the refresh logic 112, and the RAM 113. Each of the STR logic 111 and the refresh logic 112 may be a semiconductor device implementing the corresponding logic, and/or may be in the form of a module executing a program implementing the corresponding logic on the computing device 110. The supply of an operating voltage to each of the STR logic 111 and the refresh logic 112 can be the supply of the voltage used to or necessary to operate the semiconductor device or module executing the corresponding logic. The supply of the operating voltage to the RAM 113 may include the supply of a voltage necessary to drive the plurality of memory cells configuring the RAM 113.

In the STR mode, the operating voltage can be supplied to the RAM 113 so that the RAM 113 may maintain the stored data. When the operating voltage is supplied to the RAM 113, the RAM 113 may be referred to as being in an “on” state. Also, because the operating voltage can be supplied to the refresh logic 112, the RAM 113 can be refreshed by the refresh logic 112, so that the data stored in the RAM 113 may be maintained without loss.

In the STR mode, the STR logic 111 may control a switch of the operating mode of the computing device 110 from the STR mode to the sleep mode based on a result of monitoring the voltage of the battery 30 and the maintenance time of the STR mode. In the STR mode, the STR logic 111 may switch the operating mode of the computing device 110 from the STR mode to the active mode when detecting ACC on, ignition on, CAN signal reception, and the like.

The battery 30 can be a power source for supplying voltage to the power supply device 20. The two terminals (+, −) of the battery 30 can be connected to the power supply device 20, and a battery voltage VB between the two terminals (+, −) may be supplied to the power supply device 20. The battery 30 may include a main control unit (MCU) 31 that monitors the state of the battery and controls the charging and discharging operation of the battery 30. The MCU 31 may measure the battery voltage VB, measure the voltage of a plurality of battery cells that the battery 30 can include, measuring the current flowing in the battery 30, and measuring a temperature of the battery 30. The MCU 31 may estimate a charging state of the battery 30, and may control charging and discharging based on the estimated charging state. The MCU 31 may transmit information about the measured state of the battery 30 to the computing device 110 via the CAN bus 50. For example, in the STR mode, the STR logic 111 may request information about the battery voltage VB from the battery 30, and the MCU 31 may receive the request, measure the battery voltage VB in response to the request, and transmit the measured value (hereinafter, the battery voltage information) to the STR logic 111 via the CAN bus 50.

The power supply device 20 may convert the battery voltage VB supplied from the battery 30 and supply the converted voltage to various electrical equipment configuring the vehicle 1. For example, the power supply device 20 may supply various levels of voltage required for the IVI system 10 to operate. In the STR mode, the computing device 110 may provide the operating voltages from the power supply device 20 to the STR logic 111, the refresh logic 112, and the RAM 113, respectively, according to the STR logic 111.

The power supply device 20 may include an ECU 21 that controls the power supply device 20. The computing device 110 may enter the STR mode, and the STR logic 111 may transmit a signal indicating the STR mode (STR mode signal) to the power supply device 20. For example, the STR logic 111 may transmit the STR mode signal to the power supply device 20 via the CAN bus 50. In response to the STR mode signal, the ECU 21 may control the power supply device 20 to generate a plurality of voltages suitable for the operation of each of the STR logic 111, the refresh logic 112, and the RAM 113.

The ignition device 40 may receive input for manipulations, such as ignition on/off or ACC on/off, generate a signal directing the received manipulation, and transmit the generated signal to a configuration of the vehicle 1 for processing the generated signal. For example, when any one of ignition on, ignition off, ACC on, and/or ACC off is input to the ignition device 40, the ignition device 40 may transmit the signal directing the input manipulation to the IVI system 10.

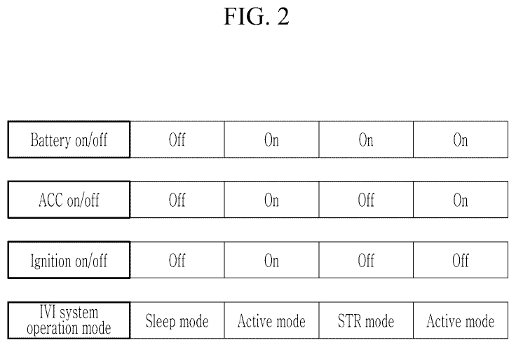

Hereinafter, the operation mode of the IVI system 10 according to an example embodiment of the present disclosure will be described with reference to FIGS. 2 to 5.

FIG. 2 is a diagram for illustrating the operation mode of the IVI system according to an example embodiment of the present disclosure.

When the battery 30 is in the off state performing no power operations, the ACC is off, and when the ignition is off, the IVI system 10 can be in the sleep mode and not operate.

When the ignition is on, the ACC is on, and the battery 30 is on, the IVI system 10 may operate in the active mode.

When the ignition is turned off and the ACC is turned off, the IVI system 10 can enter the STR mode, as opposed to conventionally operating in the sleep mode. When the computing device 110 receives an instruction directing the ignition off or the ACC off, the computing device 110 can operate according to the STR logic 111. In the STR mode, under the control of the STR logic 111, the computing device 110 may control the battery 30 to maintain the on state. The power supply device 20 may then convert the battery voltage VB supplied from the battery 30 to supply the operating voltage to the STR logic 111, the refresh logic 112, and the RAM 113.

When the ACC is turned on in the STR mode, the IVI system 10 may switch the operation mode to the active mode.

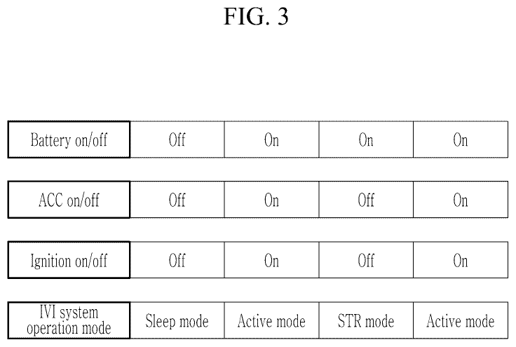

FIG. 3 is a diagram for illustrating the operation mode of the IVI system according to an example embodiment of the present disclosure.

When the IVI system 10 is in the STR mode, the ignition is turned on, and the ACC is turned on, the IVI system 10 may switch the operation mode from the STR mode to the active mode.

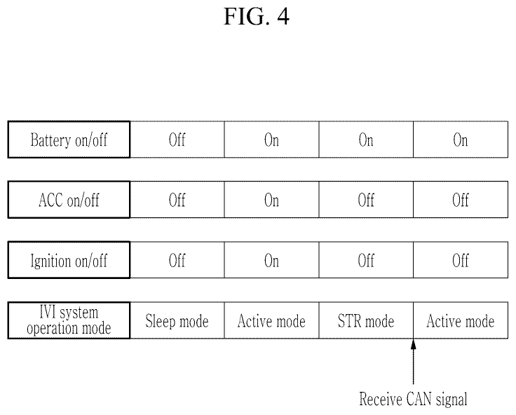

FIG. 4 is a diagram for illustrating the operation mode of the IVI system according to an example embodiment of the present disclosure.

The IVI system 10 may receive a CAN signal through the CAN bus 50 in the STR mode. The IVI system 10 can then switch the operation mode from STR mode to the active mode when receiving the CAN signal.

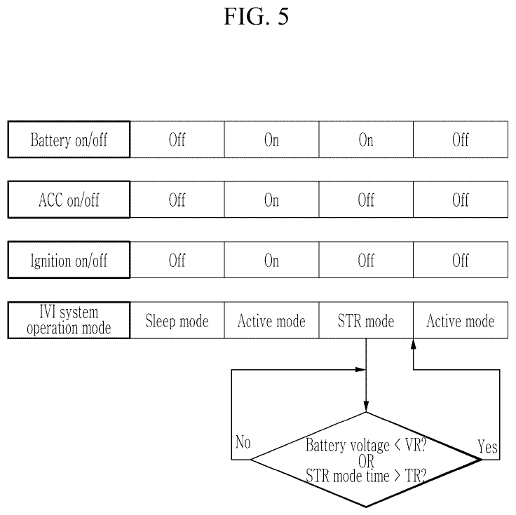

FIG. 5 is a diagram for illustrating the operation mode of the IVI system according to an example embodiment of the present disclosure.

In the STR mode, the STR logic 111 may receive battery voltage information from the MCU 31 at each monitoring period and determine if the battery voltage VB is less than a set, selected, or predetermined reference voltage VR. Further, the STR logic 111 may determine whether the time that the STR mode is maintained in the STR mode (STR mode time) is longer than a set, selected, or predetermined reference time period TR at each monitoring period in the STR mode. The STR logic 111 may include a real time clock module for counting time, and may count the time that the STR mode is maintained by using the real time clock module to determine the STR mode time.

The STR logic 111 may generate an instruction directing the switch of the operation mode to the sleep mode when the battery voltage VB becomes lower than the reference voltage VR, or when the STR mode time is longer than the reference time TR. The computing device 110 can switch the operation mode of the IVI system 10 to the sleep mode according to the instruction. In the sleep mode, the IVI system 10 can be turned off, and the battery 30 and the power supply device 20 may also be turned off. Turning off the battery 30 can be a state that the battery 30 is electrically disconnected from the power supply device 20. Turning off the power supply device 20 can be a state that the power supply device 20 receives no voltage and ceases to operate.

When the IVI system 10 switches the operation mode from the STR mode to the active mode, the IVI system 10 may perform quick booting. When the IVI system 10 switches the operation mode from the sleep mode to the active mode, the IVI system 10 may perform cold booting. The cold booting may be booting in which all operations required to boot are performed (e.g., in a manner known in the art), and the quick booting may be booting in which the booting operation of loading software into the RAM 113 and an operation of initializing the IVI system 10 that are used for or required for the IVI system 10 to operate in the cold booting can be deleted. In the operation of initializing the IVI system 10, data for the operation of the IVI system 10 can be loaded into the RAM 113, and data required for the initialization may be loaded in the state where the RAM 113 is the on state. For example, in the cold booting, the booting execution operations of the boot loader can be BL0, BL1, BL2, and BL3, but in the quick booting according to the example embodiment, operation BL3 may be omitted. That is, operation BL3 may be omitted in the quick booting because the RAM 113 is in the on state in the STR mode and the kernel and device tree blob (DTB) are loaded into the RAM 113.

However, when the quick booting is performed after a long period of time, data loss in the RAM 113 may occur. The IVI system 10 according to the example embodiment may switch the STR mode to the sleep mode for the cold booting when the quick booting in which the STR mode is switched to the active mode is maintained for a set, selected, or predetermined period of time.

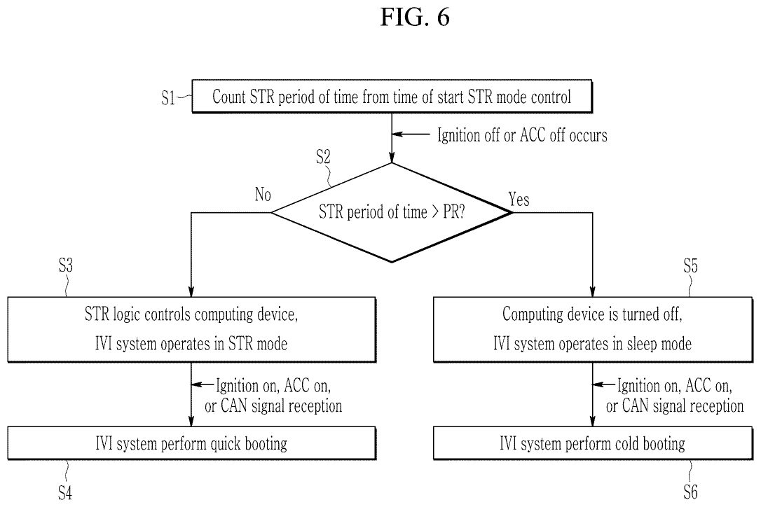

FIG. 6 is a flowchart illustrating a method of booting an IVI system according to an example embodiment of the present disclosure.

The STR logic 111 may count the passage of time from the time of start of STR mode control (operation S1). The STR logic 111 may count the passage of time from the time of the start of STR mode by using the real time clock module. The time counted by the STR logic 111 from the time of the start of STR mode can be referred to as the “STR period of time”. The STR logic 111 may ignore the switch of the operation mode from the STR mode to the active mode and may reset the counting result when the operation mode is switched to the sleep mode. That is, the STR period of time may be counted over passage of time after the start of the STR mode, as long as no sleep mode switch occurs.

When the ignition off or ACC off of the vehicle 1 occurs, the STR logic 111 may determine whether the STR period of time is longer than a set, selected, or predetermined reference period of time PR (operation S2).

When the STR period of time is shorter than the reference period of time PR (No at operation S2) as a result of the comparison in operation S2, the STR logic 111 may control the computing device 110, and the IVI system 10 may operate in the STR mode (operation S3). The operation of the IVI system 10 in the STR mode may be the same as the operation of the example embodiments referenced in FIGS. 2 to 5, for example.

When any one of the ignition on, ACC on, or CAN signal reception occurs, the IVI system 10 can perform quick booting (operation S4).

When the STR period of time is longer than the reference period of time PR as a result of the comparison in operation S2, the STR logic 111 may turn off the computing device 110, and switch the operation mode of the IVI system 10 to the sleep mode. That is, the IVI system 10 can operate in the sleep mode in which the system is the off state (operation S5).

When any one of the ignition on, ACC on, or CAN signal reception occurs, the IVI system 10 can perform cold booting (operation S6).

As described above, according to the example embodiments, it can be possible to provide quick booting by controlling the IVI system in the STR mode even during ignition off or ACC off. Furthermore, according to the example embodiments, to prevent data loss in the RAM that may occur due to the STR mode and quick booting, it can be possible to limit the STR mode maintenance time and the STR period of time during which quick booting can be performed.

For example, when the vehicle is intended to deliver goods, the driver would like to receive route guidance through the IVI system as soon as the driver gets in the vehicle, to deliver the goods in a quick time. The vehicles in the related art have difficulty meeting such a need because the IVI system performs cold booting at ignition on. An embodiment of the present disclosure may solve the problem of data loss from the RAM of the IVI system, while providing quick booting to meet the foregoing need.

The accompanying drawings and the detailed description above are only example embodiments of the present disclosure, which can be used for the purpose of describing the present disclosure but do not necessarily limit the meanings or the scopes of the present disclosure described in the claims. Therefore, those skilled in the art can easily select and replace constituent elements of an example embodiment based on the description. Further, those skilled in the art can omit some of the constituent elements of an example embodiment described in the present specification without deterioration of performance or add constituent elements for improving performance. In addition, those skilled in the art may also change the order of the operations of a method embodiment described in the present specification according to a process environment or equipment. Accordingly, the scopes of the present disclosure can be determined by the claims and the equivalent thereof, not merely by the described example embodiment.

What is claimed is:

1. An in-vehicle infotainment (IVI) system of a vehicle, the IVI system comprising a computing device configured to control an operation of the IVI system, wherein the computing device comprises:
a random access memory (RAM) configured to store information for an operation of the computing device; and
suspended-to-random-access-memory (STR) logic configured to control the IVI system in an STR mode in response to ignition or an accessory (ACC) mode of the vehicle being off, and
wherein the computing device is configured to provide a first operating voltage to the RAM and a second operating voltage to the STR logic in the STR mode in accordance with the STR logic.

2. The IVI system of claim 1, wherein, in response to ignition on, ACC on, or CAN signal reception of the vehicle occurring while in the STR mode, the IVI system is configured to be switched to an active mode in which the IVI system operates according to a program executed by the computing device.

3. The IVI system of claim 2, wherein in response to the STR mode being switched to the active mode in response to ignition on, ACC on, or CAN signal reception of the vehicle occurring while in the STR mode, the IVI system is configured for quick booting of the IVI system to be performed, and
in the quick booting, a booting operation of loading software to the RAM and an initialization operation for initialization of the IVI system are skipped.

4. The IVI system of claim 1, wherein the computing device further comprises refresh logic configured to refresh-operate the RAM, and
wherein, while in the STR mode, according to the STR logic, the computing device is configured to provide a third operating voltage to the refresh logic.

5. The IVI system of claim 1, further comprising:
a battery; and
a power supply device configured to convert a battery voltage of the battery to supply a converted voltage to the IVI system, and
wherein, in the STR mode, the power supply device is configured to generate the respective first and second operating voltages of the RAM and the STR logic.

6. The IVI system of claim 5, wherein, in response to the battery voltage of the battery becoming lower than a reference voltage, or an STR mode time in which the STR mode is maintained being longer than a reference time, the IVI system is configured so that the STR logic switches the IVI system to a sleep mode.

7. The IVI system of claim 1, wherein the IVI system is configured so that the STR logic counts passage of time from time of start of control of the STR mode to generate an STR period of time, and in response to the STR period of time being longer than a reference period of time, the STR logic turns off the computing device to switch the IVI system to a sleep mode.

8. The IVI system of claim 7, wherein the IVI system is configured so that in response to the IVI system being in a sleep mode and in response to any one of or any combination of ignition on, ACC on, or CAN signal reception of the vehicle occurring, the IVI system performs cold booting.

9. A method of controlling an operation of an in-vehicle infotainment (IVI) system of a vehicle, the method comprising:
controlling the IVI system in a suspended-to-random-access-memory (STR) mode in response to ignition or an accessory (ACC) of the vehicle being off; and
supplying a first operating voltage to each of a random access memory (RAM) and STR logic controlling the STR mode while in the STR mode, wherein the RAM stores information for control of the IVI system.

10. The method of claim 9, further comprising, in response to ignition on, ACC on, or CAN signal reception of the vehicle occurring while in the STR mode, switching the IVI system to an active mode in which the IVI system operates according to an installed program.

11. The method of claim 10, further comprising, in response to switching from the STR mode to the active mode, performing quick booting of the IVI system, wherein in the quick booting, a booting operation of loading software to the RAM and an operation of initialization of the IVI system are skipped.

12. The method of claim 9, further comprising:
refresh-operating the RAM by refresh logic; and
in the STR mode, supplying a second operating voltage to the refresh logic.

13. The method of claim 9, further comprising, in response to a battery voltage of a battery connected to a power supply device supplying voltage to the IVI system falling below a reference voltage, switching, by the STR logic, the IVI system to a sleep mode.

14. The method of claim 9, further comprising, in response to an STR mode time in which the STR mode is maintained being longer than a reference time, switching, by the STR logic, the IVI system to a sleep mode.

15. The method of claim 9, further comprising:
counting, by the STR logic, passage of time from time of start of control of the STR mode to generate an STR period of time; and
in response to the STR period of time being longer than a reference period of time, switching, by the STR logic, the IVI system to a sleep mode.

16. The method of claim 15, further comprising, in the sleep mode in response to
any one of or any combination of ignition on, ACC on, or CAN signal reception of the vehicle occurring, performing, by the IVI system, cold booting.

17. A method of controlling an operation of an in-vehicle infotainment (IVI) system of a vehicle, the method comprising:
putting the IVI system in a suspended-to-random-access-memory (STR) mode in response to ignition or an accessory (ACC) of the vehicle being initially off;
supplying a first operating voltage to each of a random access memory (RAM) and STR logic controlling the STR mode while in the STR mode, wherein the RAM stores information for control of the IVI system;
in response to the ignition on, ACC on, or CAN signal reception of the vehicle occurs while in the STR mode, switching the IVI system to an active mode in which the IVI system operates according to an installed program;
in response to switching from the STR mode to the active mode, performing quick booting of the IVI system, wherein in the quick booting, a booting operation of loading software to the RAM and an operation of initialization of the IVI system are skipped;
refresh-operating the RAM by refresh logic; and
when in the STR mode, supplying a second operating voltage to the refresh logic.

18. The method of claim 17, wherein a battery voltage of a battery connected to a power supply device supplying voltage to the IVI system falls below a reference voltage while in the STR mode, the method further comprising switching, by the STR logic, the IVI system to a sleep mode.

19. The method of claim 17, wherein an STR mode time in which the STR mode is maintained is longer than a reference time, the method further comprising switching, by the STR logic, the IVI system to a sleep mode.

20. The method of claim 17, further comprising:
while in the STR mode, counting, by the STR logic, passage of time from time of start of control of the STR mode to generate an STR period of time;
in response to the STR period of time being longer than a reference period of time, switching, by the STR logic, the IVI system to a sleep mode; and
while in the sleep mode, performing, by the IVI system, cold booting in response to any one of or any combination of ignition on, ACC on, or CAN signal reception of the vehicle occurring.
